(19) United States
(12) Patent Application Publication
(10) Pub. No.: US 2007/0050273 A1
(43) Pub. Date: Mar. 1, 2007

(54) System and method for presenting price movements before or following recurring historical events

(75) Inventor: P.D.M. Gibbons Burke JR., New Orleans, LA (US)

Correspondence Address: PERRY HOFFMAN & ASSOCIATES P.C., PO BOX 1649, DEERFIELD, IL, 60015, US

(73) Assignee: Logical Information Machines, Inc.

(21) Appl. No.: 11/209,513

(22) Filed: Aug. 23, 2005

(51) Int. Cl. G06Q 40/00

(52) U.S. Cl. 705/35

(57) ABSTRACT

Computer systems and methods handling information about price movements of a financial instrument before or following a recurring historical event by specifying target financial instruments, recurring historical events, and computing returns of financial instruments each relative to a substantially single respective reference time, for a plurality of distinct times during a respective time period in proximity to a time of the respective prior occurrence. As described, the return of the financial instrument, at a given time, may show relative percentage change of a price of the financial instrument between the reference time and the given time, which may include specifying the target financial instrument and the historical event, for each of a plurality of respective prior occurrences of the historical event, accessing a set of price data of the financial instrument during a respective time period in proximity to a time of the respective prior occurrence, and determining a respective substantially single reference time. According to some embodiments, the method further includes effecting a re-scaling, where for each respective proximate time period, each respective accessed set of price data is re-scaled to a substantially common price or performance scale by computing, e.g., as a function of a price of the financial instrument at the distinct times and a price of the financial instrument at the respective reference time or historical events.

### BACKGROUND OF THE INVENTION

1. Field of the Invention

The present invention relates to systems and methods for presenting historical information about price movements of financial instruments.

2. Description of the Related Art

Traders, portfolio managers, investors and other market players are always seeking out improved techniques for predicting future prices and price movements of different financial instruments (e.g. securities, commodities, derivatives). One approach towards predicting future price movements is known as technical analysis. The proponents of technical analysis believe that financial instruments prices react to market events with a certain degree of consistency over time, and thus, future price movements can, in many situations, be forecast by studying past price movements.

Although data describing past price movements is often readily available from automated information search and retrieval systems, detecting specific tradable patterns in price movements can be a challenging task. There is an ongoing need for methods and systems that aid market players in the task of identifying these tradable patterns from historical price movements.

U.S. Pat. Nos. 5,414,838, 5,590,325 and 5,778,357, all of which are incorporated herein by reference in their entirety, disclose a system and method for querying commodity price (e.g. stock price) information databases. A user provides a query specifying trading date attributes including calendar events such as national holidays and triple-witching hours and/or fundamental events such as dates of political elections, dates a particular stock had a closing price above or below a certain level, dates of company earnings reports, dates of release of economic information (e.g. consumer price index) and so on. The query can be provided in a near natural language format.

For each date in history satisfying the conditions of the query, a graph of the commodity price during a time period proximate to the date is provided. The aforementioned patent documents disclose that visual comparison among a plurality of these graphs (FIG. 1) allows for identification of recurring trends.

The aforementioned patent documents further disclose that comparison among the plurality of graphs as shown in FIG. 1 allows a trader to hypothesize a particular market test. Nevertheless, the particular case of FIG. 1 relates to an historical event with only five pervious occurrences, and thus the trader would only need to compare among five graphs. For historical events with a larger number of occurrences, it becomes more difficult to hypothesize the particular market using the techniques disclosed in U.S. Pat. Nos. 5,414,838, 5,590,325 and 5,778,357.

Furthermore, even if one were to hypothesize that buying or selling a particular instrument at the time of the event is advisable, it is difficult determine from these graphs when the optimum time before or after the event to effect the purchase is, and it is difficult to determine the optimum horizon to maintain the position before taking profit. Furthermore, it is difficult to determine from these graphs any relationship between the risk of buying or selling the asset and the potential payout.

There is an ongoing need for methods and tools for aiding traders and other market players in deciding, based upon past performance data, whether or not to purchase or sell particular financial instruments, and for how long to hold on to the targeted financial instruments, during time frame in proximity of recurring historical events.

### SUMMARY OF THE INVENTION

The aforementioned needs are satisfied by several aspects of the present invention.

It is now disclosed for the first time a method of providing information about prices or price movements before or following a recurring historical event. The presently disclosed method includes specifying the target financial instrument, specifying or defining the recurring historical event, and computing a return of the financial instrument relative to a substantially single respective reference time for each of a plurality of respective prior occurrences of the historical event, for a plurality of distinct times during a respective time period in proximity to a time of the respective prior occurrence. In some embodiments, the method further includes presenting at least one function of the computed returns.

According to some embodiments, each respective reference time has substantially the same relation to respective time of respective prior occurrence.

According to some embodiments, each respective reference time occurs within one trading day of a respective time of a respective prior occurrence.

According to some embodiments, each respective reference time is a substantially fixed time of a trading date. Exemplary trading dates include but are not limited to trading dates during which the respective historical event occurs, and a first trading date after the respective occurrence of the historical event.

According to some embodiments, the substantially fixed time within a trading date is substantially a close of trading.

According to some embodiments, each respective reference time has a substantially equal time offset from the respective time of occurrence of the historical event.

According to some embodiments, for each respective reference time, a time difference between the respective reference time and the respective time of occurrence is at most a predetermined value.

According to some embodiments, each respective reference time is a respective time of occurrence of the historical event.

According to some embodiments, for a given distinct time, the computing of the return includes computing a difference between a price of the financial instrument at a given distinct time and a price of the financial instrument at the respective reference time.

According to some embodiments, for a given distinct time, the computing of the return includes dividing the difference by a price of the financial instrument at the respective reference time.

According to some embodiments, for a given time, the return of the financial instrument is a function of a relative percentage change of a price of the financial instrument between the reference time and the given time.

According to some embodiments, a difference between each distinct time during the proximate time period and a time of the respective occurrence is at most 50 trading days.

According to some embodiments, each respective proximate time period is a multi-trading day time period, and for each respective proximate time period, the return is computed for times on different trading days.

According to some embodiments, one presented function is substantially an identity function, and the presenting includes presenting the respective individual computed returns for each of the plurality of prior occurrences.

According to some embodiments, a plurality of functions is presented, each respective function of the plurality is associated with a respective prior occurrence, and the plurality of functions is presented using a substantially common time scale relative to said respective historical events.

According to some embodiments, one presented function is a function of a plurality of individual computed returns.

According to some embodiments, one function is a measure of a central tendency or an average of individual computed returns.

According to some embodiments, one function is a measure of variability among individual computed returns.

According to some embodiments, one function is a measure of a relation between an average of individual computed returns and the variability of the individual computed returns.

According to some embodiments, one function is a discrete function derived from a plurality of threshold values and a relation between an average of individual computed returns and the variability of the individual computed returns.

According to some embodiments, the discrete function vanishes for a given time if an absolute value of a value of said relation is below a threshold value.

According to some embodiments, one function is proportional to a ratio between an average of individual computed returns and a standard deviation of among individual computed returns.

According to some embodiments, one function is selected from the group consisting of a minimum return among individual computed returns, a maximum return among individual computed returns, a function of only individual computed returns that are positive, a function of only individual computed returns that are negative, a function proportional to a fraction of individual computed returns that are positive and a function proportional to a fraction of individual computed returns that are negative.

According to some embodiments, the target financial instrument is selected from the group consisting of a marketable security, a commodity price, a commodity future, an index of a plurality of financial instruments, an option, and a financial derivative.

According to some embodiments, the specifying of the financial instrument includes the steps: for a given trading day, specifying a plurality of candidate financial instruments and at least one event definition, presenting identifiers for at least a sub-plurality of candidate financial instruments selected from the plurality of financial instruments that each satisfy criteria of one event definition on the given trading day, selecting a candidate financial instrument from sub-plurality, to specify financial instrument.

According to some embodiments, the given trading day is selected from the group consisting of a current trading day, a most recent trading day, and a next trading day.

According to some embodiments, each candidate financial instrument is associated with at least one financial instrument category, the specifying of the financial instrument further includes specifying the financial instrument category and the presenting of the identifiers includes presenting only identifiers of financial instruments associated with said specified financial instrument category.

According to some embodiments, the financial instrument is a stock, and the financial instrument category is the category of all stocks included in a stock index.

According to some embodiments, a plurality of financial instrument categories is presented, and the specified financial instrument category is selected from the plurality of presented financial instrument categories.

According to some embodiments for each financial instrument category and for each event definition, an indication of how many candidate financial instruments in said respective financial category satisfied criteria of said respective event definition is presented.

According to some embodiments, the specifying of the at least one event definition provides the definition of the recurring historical event.

According to some embodiments, the defining of the historical event includes specifying at least one characteristic of at least one trading date selected from the group consisting of a trading day of event, the first trading day following the historical event, and a trading day occurring a defined number of trading days before the historical event. According to some embodiments, the defined number is at most five.

According to some embodiments, the defining of the historical event includes the steps of specifying a reference financial instrument, specifying a reference trading date, for at least one trading day associated with the reference trading day, for a plurality of trading day characteristics, displaying an indication of whether or not on the associated trading day the reference financial instrument exhibited a trading day characteristic, resenting an input user interface for defining characteristics of a trading day associated with the historical event, where user interface includes the displayed indications, and receiving directives to define the historical event through said input user interface.

According to some embodiments, an absolute value of a time difference between a time of said reference trading day and said associated trading day is at most five trading days.

According to some embodiments, the defining of the historical event includes specifying trading dates associated with an almanac status or event.

According to some embodiments, the defined historical event is a composite historical event.

According to some embodiments, the defining of the historical event includes specifying an input event that occurs a fixed time before or after said defined historical event.

According to some embodiments, the defining of said historical event includes the steps of presenting a plurality of identifiers of input events, each input event associated with a given trading day, selecting at least a sub-plurality of the plurality of input events, and defining the historical event to be an event that occurs when the inputs events of the selected sub-plurality occur.

According to some embodiments, the defining and computing are carried out more than once, each historical event must satisfy a number of requirements, and a number of satisfied requirements of a historical event defined by a latter iteration is a greater than a number of satisfied requirements defined by an earlier iteration.

According to some embodiments, the defining and computing are carried out more than once, each historical event is associated with a number of occurrences, and a number of said occurrences of a historical event defined by a latter iteration is a smaller than a number of occurrences defined by an earlier iteration.

It is now disclosed for the first time a method of providing information about prices or price movements before or following a recurring historical event. The presently disclosed method includes the steps of specifying the target financial instrument and the historical event, for each of a plurality of respective prior occurrences of the historical event, accessing a set of price data of the financial instrument during a respective time period in proximity to a time of the respective prior occurrence, and determining a respective substantially single reference time. According to some embodiments, the method further includes effecting a re-scaling, where for each respective proximate time period, each respective accessed set of price data is re-scaled to a substantially common price or performance scale by computing, for a respective plurality of distinct times during each respective proximate time period, a function of a price of the financial instrument at the distinct times and a price of the financial instrument at the respective reference time.

According to some embodiments, the method further includes presenting at least one function of the re-scaled data using a substantially common time scale relative to the respective historical events.

According to some embodiments, the computing of the function includes computing a difference function.

According to some embodiments, the re-scaling includes using the substantially single reference time from a first trading day to re-scale price data from a plurality of other trading days.

It is now disclosed for the first time computer readable storage medium having computer readable code embodied on the computer readable storage medium, the computer readable code for providing information about price movements before or following a recurring historical event, the computer readable code including instructions for specifying the target financial instrument, defining the recurring historical event, for each of a plurality of respective prior occurrences of the historical event, for a plurality of distinct times during a respective time period in proximity to a time of the respective prior occurrence, computing a return of said financial instrument relative to a substantially single respective reference time, and presenting at least one function of the computed returns.

It is now disclosed for the first time computer readable storage medium having computer readable code embodied on the computer readable storage medium, the computer readable code for providing information about price movements before or following a recurring historical event, the computer readable code including instructions for specifying the target financial instrument and the historical event, for each of a plurality of respective prior occurrences of the historical event, accessing a set of price data of the financial instrument during a respective time period in proximity to a time of the respective prior occurrence, for each respective proximate time period, determining a respective substantially single reference time, and re-scaling each respective accessed set of price data to a substantially common price or performance scale by computing, for a respective plurality of distinct times during each respective proximate time period, a function of a price of the financial instrument at the distinct time and a price of the financial instrument at the respective reference time.

It is now disclosed for the first time a system for providing information about price movements before or following a recurring historical event. The presently disclosed system includes an input interface for specifying the target financial instrument and the recurring historical event, a data retrieval engine for accessing price data of the target financial instrument during respective time periods in proximity of a plurality of respective occurrences of the recurring historical event, and a data transformation engine for computing, for each of a plurality of respective prior occurrences of the historical event, for a plurality of distinct times during a respective time period in proximity to a time of the respective prior occurrence, a return of the financial instrument relative to a single respective reference time, and a presentation interface for presenting at least one function of the computed returns.

It is now disclosed for the first time a system for providing information about price movements before or following a recurring historical event. The presently disclosed system includes an input interface for specifying the target financial instrument and the recurring historical event, a data retrieval engine for accessing, for each of a plurality of respective prior occurrences of the historical event, a set of price data of the financial instrument during a respective time period in proximity to a time of the respective prior occurrence, a data transformation engine for re-scaling each respective accessed set of price data to a substantially common price or performance scale by computing, for a respective plurality of distinct times during each respective proximate time period, a function of a price of the financial instrument at the distinct time and a price of the financial instrument at the respective reference time, and a presentation interface for presenting at least one function of the computed re-scaled price data.

These and other embodiments of the present invention will become apparent in conjunction with the figures, description, appendix and claims that follow.

### BRIEF DESCRIPTION OF THE DRAWINGS

FIG. 1 provides an image of graphs generated by a prior art data access system;

FIG. 2 provides a block diagram of an exemplary system for presenting historical information about price movements and/or returns of a financial instrument according to some embodiments of the present invention;

FIG. 3 provides a block diagram of an exemplary method for presenting historical information about price movements and/or returns of a financial instrument according to some embodiments of the present invention;

FIG. 4 provides exemplary graphical output of historical information about returns of a financial instrument;

FIG. 5 provides an exemplary interface for selecting a financial instrument and/or defining an event;

FIG. 6 provides an interface for selecting a financial instrument from a plurality of candidate financial instruments;

FIGS. 7-8 further provide exemplary graphical output of historical information about returns of a financial instrument; and

FIG. 9 provides an interface for specifying a historic event in accordance with data presented about behavior of a financial instrument during a plurality of trading days.

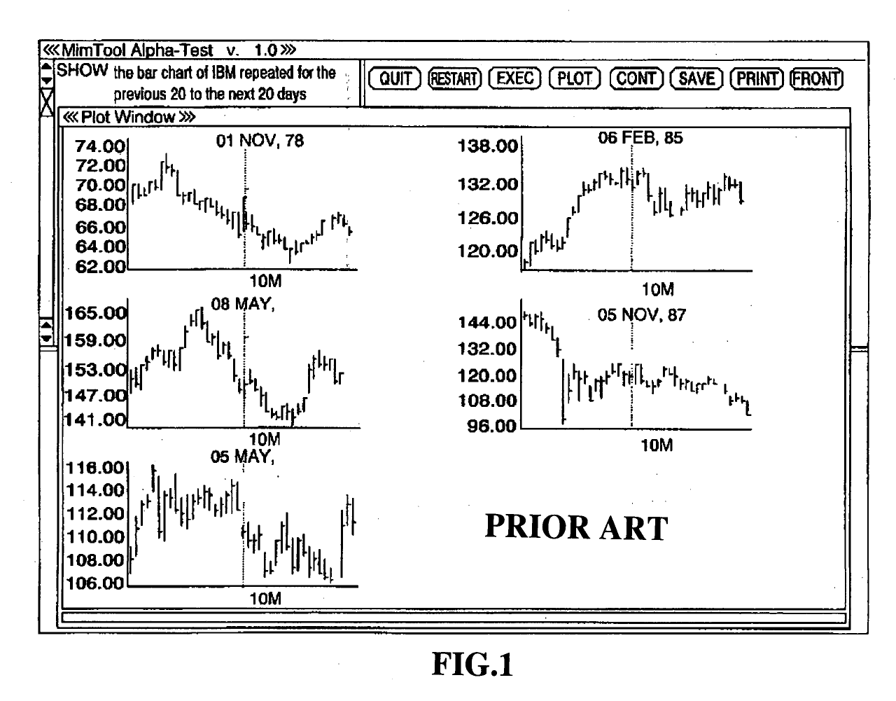

### DETAILED DESCRIPTION OF THE PREFERRED EMBODIMENTS

The present invention will now be described in terms of specific, example embodiments. It is to be understood that the invention is not limited to the example embodiments disclosed. It should also be understood that not every feature of the methods, apparatus and computer readable code for displaying information about price movements and returns of financial instruments described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first. Furthermore, it is noted that any component of the computerized systems and any step of the methods disclosed herein may be implemented using software, hardware or any combination thereof.

According to some embodiments, the present invention relates to a trade discovery tool operative to assist the user (e.g. a trader) in performing at least one of three tasks: observing the current situation for a given financial instrument and/or market and presenting to the user a matrix of events that have recently occurred for that instrument, selecting a particular historical event or combination of events of interest which purportedly can influence price movements of a given financial instrument, and detecting whether or not the historical event generates a repeating pattern of temporal price movement pattern which may represent a trading opportunity.

For convenience, certain terms employed in the specification, examples, and appended claims are collected here.

Examples of “financial instruments” include but are not limited to marketable securities (e.g. stocks, bonds and the like), futures contracts (e.g. treasury bond futures, heating oil futures and the like), physical tradable commodities (e.g. metals, grains, oil and the like), options, derivatives, and foreign currencies. The term “financial instrument” is also intended to encompass any combination or “basket” of other financial instruments. In one example, a stock index, composed of a weighted basket of a plurality of stocked is also considered a financial instrument. Furthermore, according to some embodiments, users can specify customized combinations or baskets of financial instruments, and the customized combinations or baskets of are in themselves considered financial instruments.

Each financial instrument is associated with a temporally varying “price” which reflects the value of the financial instrument. It is appreciated that although certain financial instruments might not be readily tradable at a specific time (because, for example they are a customized combination of financial instruments), they still have a “price” which reflects their value.

According to some embodiments, a “respective prior occurrence” is one particular prior occurrence of a historical event. Thus, for the well known and apparently trivial example where the recurring historical event is an inauguration of a president, respective prior occurrences were on Jan. 20, 1977 (Jimmy Carter), Jan. 20, 1981 (Ronald Reagan ), Jan. 21, 1985 (Ronald Reagan), Jan. 20, 1989 (George HW Bush), Jan. 20, 1993 Jan. 20, 1997 (William J. Clinton), Jan. 20, 2001 and Jan. 20, 2005 (George W. Bush).

It is noted that a “time of a prior occurrence” can, in different embodiments and for different historical events, be determined using different time granularities. In some embodiments, the “time of the prior occurrence” is determined according to a minute granularity, or according to an hourly granularity. In some embodiments, a “time of the prior occurrence” is determined according to the nearest or according to a particular trading day.

Thus, in one example, a “profit warning” is a historical event which may be treated in one of a number of ways. For example, the event may be associated with a particular trading day or a fixed time within a trading day (e.g. close of trading). Thus, in some embodiments, a first respective profit warning occurs at 10 AM, a second respective profit warning occurs at 2 PM, but since the “time of the respective historic event” is treated with a “trading day granularity,” the “time of the respective prior occurrence” and/or the “respective reference” time of the profit warning is given only by the trading date associated with the date. Alternatively, the “time of the respective historic event” is actually determined according to a sub-trading day granularity (e.g. an hourly or minute granularity).

In the event that the respective historical event and/or the reference time associated with the respective historical event is determined according to a “trading day granularity” there are number of conventions for associating a particular trading day with a time of a respective occurrence of the historical event. Thus, in some embodiments, a historical event is associated with a fixed time during a trading day, e.g. a close of trading. According to one convention, historical events that occur after the close of trading are associated with the next trading day.

Thus, different embodiments of the present invention use different conventions for relating a time of a respective occurrence and/or respective reference times and/or “distinct times” of a respective plurality of times for which a re-scaling and/or return is computed to a trading day or a particular time in a trading day.

Furthermore, it is noted that more than one convention for defining a “time period in proximity” of a respective historic event, or “proximate time period,” is appropriate for the present invention. In some embodiments, the time of the respective historic event is in the proximate time period or is an endpoint of the proximate period, though this is not a limiting requirement of the present invention. Thus, the “proximate time period” may include times that are most 50 trading days or at most 30 trading days or most 10 trading days or at most 5 trading days or most 1 trading day or at most several hours or at most 1 hours from a time of a respective occurrence.

Some embodiments of the present invention provide for a computing of a return of a financial instrument relative for several times relative to “single respective reference time,” for example, a given time on a trading day, as opposed to, for example, for a plurality of trading days, computing the daily return relative to a price of the previous trading day (e.g. pct change for each day).

Thus, according to some embodiments, each substantially single respective reference time occurs on the same trading day. According to some embodiments, each substantially single respective reference time occurs within a period of at most 4 hours or within a period of at most 2 hours or within a period of at most 1 hour or within a period of at most ½ hour or within a period of at most 10 minutes.

According to some embodiments, a price of the financial instrument remains stable during a “a substantially single respective reference time” within a tolerance or at most 1%, at most ½%, at most ¼% or at most 0.1%.

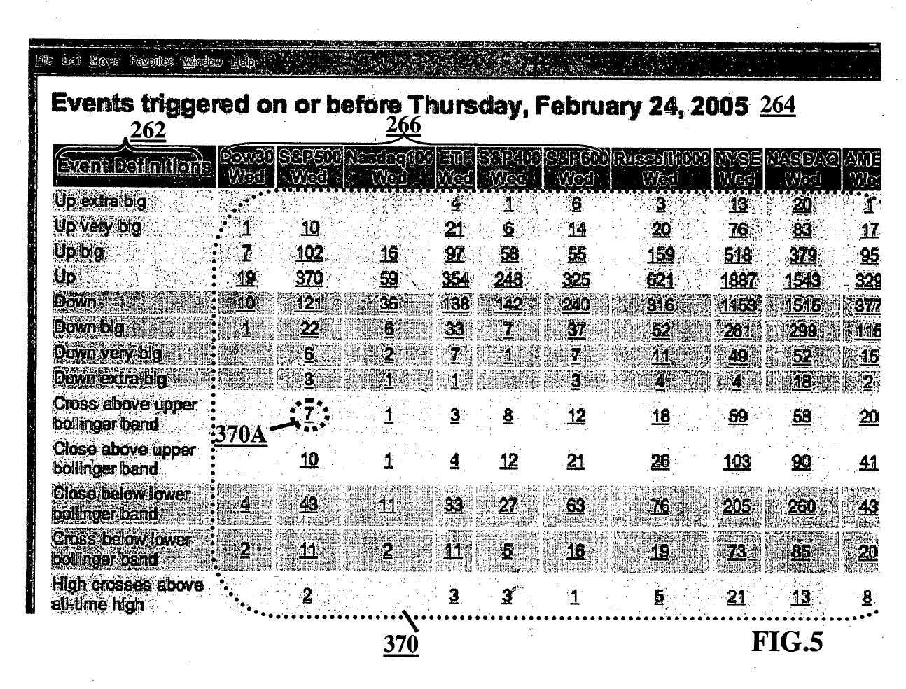

It is noted that in some embodiments, the “defining of the recurring historical event” includes a specifying a recurring historical event. Alternatively or additionally, a historical event may be defined in terms of one or more “event definitions” (for example, see column 262 of FIG. 5).

It is noted that “event definitions” or requirements that an historical event must satisfy is not limited to the specific case where an event is defined in terms of a trading day. Nevertheless, it is noted that as applied to the specific case where an event is defined in terms of a trading day, any trading day is a potential candidate for a previous occurrence of an historical event. Thus, the “event definitions” or “requirements that an historical event must satisfy” function as filters—e.g. every trading day is a potential candidate to be denoted a “previous occurrence,” yet only trading days which satisfy every event definition is selected as a trading date of a previous occurrence. In one example, a single “event definition” suffices to define a trading date of a historical event. In another example, the historical event is a “composite” historical event defined by a plurality of “event definitions,” for example a day where a specific financial instrument is down big and also where the dollar is down.

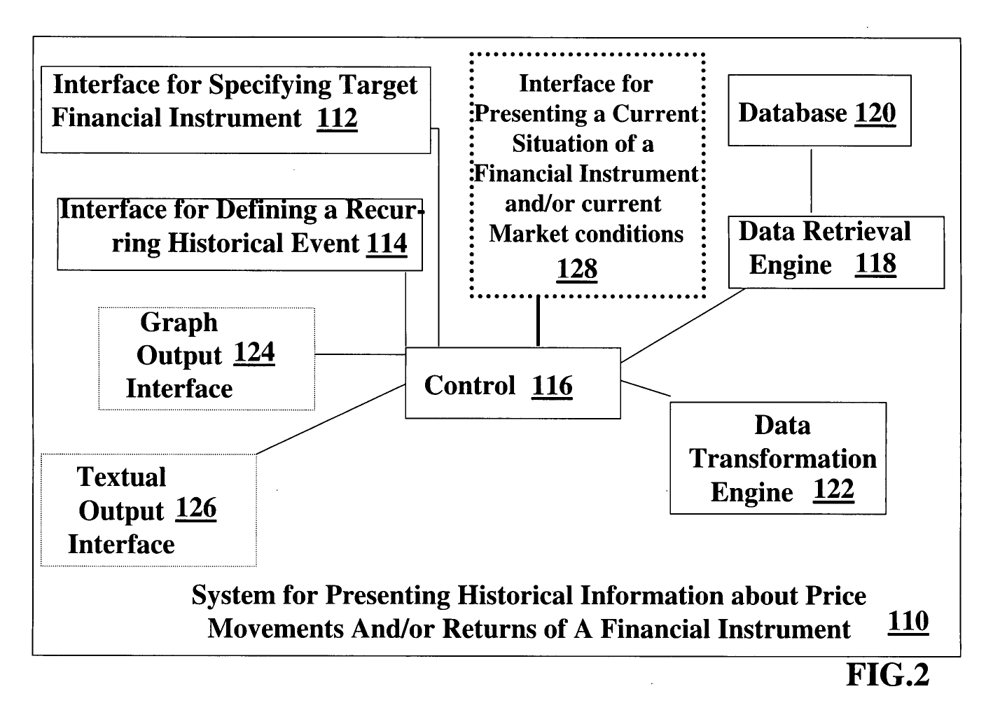

FIG. 2 provides a block diagram of an exemplary system 110 for presenting information about price movements and/or returns of financial instruments according to exemplary embodiments of the present invention. The system includes an interface for specifying a target financial instrument 112 as well as an interface for defining a recurring historical event 114. According to some embodiments, the interfaces 112 and 114 are collectively part of what is denoted a input user interface, though it is noted that any input user interface operative to receive directives to specify one or more financial instruments and one or more one or historical events is appropriate for the present invention.

As illustrated in FIG. 2, the system further includes a database 120 containing information about historical market events and about the price history of various financial instruments. The database is accessed by a data retrieval engine 118 in accordance with directives received through the input interfaces 112 and 114. Alternatively, the database 120 is an external database that is not a system component, and the data retrieval engine 118 accesses data from the external database.

Data retrieved from the database 118 is transformed by the data transformation engine 122, operative to re-scale the retrieved data and/or compute a return of the financial instrument for a plurality of distinct times during a respective time interval associated with a respective historical event. Optionally, the transformed data is presented using at least one output interface such as a graph output interface 124 which graphically presents the transformed historical data and/or a textual output interface 126 which textually presents the transformed historical data. Optionally, the system includes a view presenter for presenting one or more views (e.g. graphical and/or text views) selected from a plurality of possible views.

There is no explicit limitation on the optional “control” 116 of FIG. 2. Any implementation of the control configured such that the elements of FIG. 2 appropriately communicate and/or work together is appropriate for the present invention.

Optionally, the system 110 further includes an interface 128 for presenting a current situation of a financial instrument and/or current market conditions.

It is noted that the according to different embodiments, the system including one or more components disclosed in FIG. 2 is operative to implement any method disclosed herein.

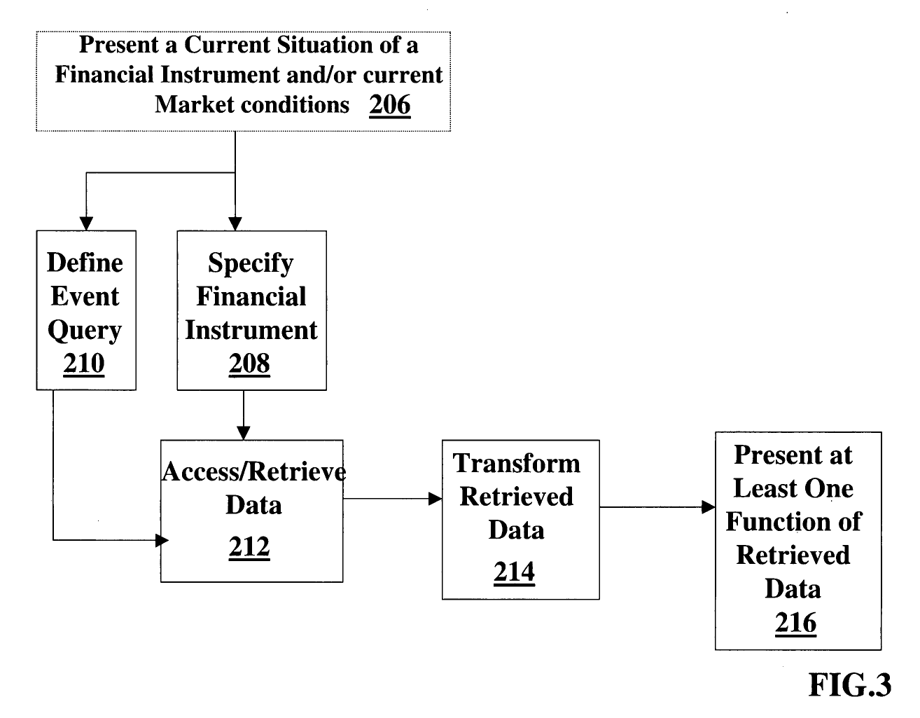

FIG. 3 provides a flowchart of a method for displaying information about historic price movements and/or return of the financial instrument according to some embodiments of the present invention. Thus, as shown in FIG. 2, historical price data about a previously specified financial instrument 208 is retrieved 212 from database 120 for a plurality of time periods. Each respective time period is in proximity to a respective historical event defined 210 by an event query received through the interface for defining the recurring historical event 114.

Optionally, the event is defined 210 and the financial instrument is specified 208 by the user in accordance with current situation of a financial instrument and/or current market conditions presented 206 to a user.

The retrieved historical price data is transformed 214 into data describing a return of the financial instrument relative to the time of each respective historical. Alternatively or additionally, the retrieved historical price data is transformed 214 by re-scaling each set of price data for each respective historical event to a substantially common price and/or performance scale. At least one function of the retrieved data is presented 216 through the graph output interface 124 and/or the text output interface 126.

It is noted that there is no specific limitations on the form of the accessed “set of price data.” According to exemplary embodiments, this data is provided in the form of a price time series. Alternatively or additionally, this data is provided as a set of coefficients for a function (e.g. an interpolation function such as a spline), where the value of the function approximates the price for given times in the relative time period.

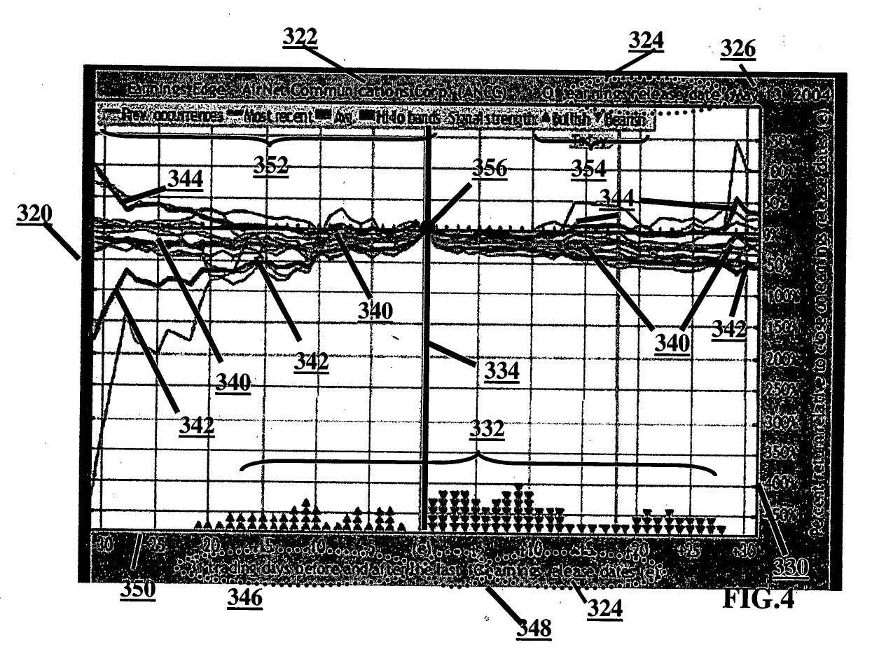

FIG. 4 provides an image of an exemplary “Earnings Edge” report produced by the graph output interface 124 presenting 216 at least one function of the historical price data accessed or retrieved 212 from the database 120 according to some embodiments of the present invention. The financial instrument 322 that is the subject of the generated report of FIG. 4 is the stock AirNet Communications Corp. (ANC), and the recurring historical event 324 is the earnings release date.

The chart 320 of FIG. 4 illustrates how AirNet Communications Corp. (ANC) has performed relative its previous 10 earnings announcements. It is noted that for each respective earnings announcement, time dependent price data is transformed to data of a return of the stock relative to a respective reference time (in this case the respective reference time is a closing time on a trading day associated within a respective earnings announcement). Although for each respective earnings release the data relates to a different time period, the price data for time before and after (e.g. in proximity of) each respective earnings release is presented on a substantially common time scale relative to the respective earnings release date.

The closing price on the earnings release date is represented by the dot 356 at the zero-percent return line along the vertical bar representing the time of the respective historical event (e.g. the time of respective the earnings announcement). Price movement relative to that date for each of the last prior 10 occurrences 348 is shown to the left (the before period) and right (the after period) by the thin lines for individuals occurrences of the historical event (earnings announcement). The most recent 326 earnings release date is May 13, 2004. Although the return relative to the time of the respective historical event (e.g. the earnings release date represented by line 334) is computed and presented in FIG. 4, it is appreciated that other embodiments of the present invention, the return may be computed relative to another “reference time” having a fixed time offset from each respective historical event (e.g. earnings release date).

The horizontal axis 350 displays time in trading days unit relative to the respective occurrence of the historical event (earnings release date). As shown in FIG. 4, 31 days before and after 346 the historical event are plotted for each individual occurrences.

Furthermore, the average of all these returns for each data is represented by average line 340. It is noted that the average line 340 is below the zero return line before the time of the event with an upward slope, indicating bullishness before the event. At the time of the event, the average line 340 line, by definition, reaches a zero return relative to close on the earnings release dates. After the earnings release date, average line 340 once again returns to negative values, indicating a bearish trend. Thus, the graph of FIG. 4, which exhibits bullish tendencies before the earnings release and bearish tendencies after the earning release, can be said to adhere to a “buy on the rumor, sell on the news” pattern of behavior.

It general, it is noted that an upwardly sloping average line indicates that as time passes, the average return increases, and is thus indicative of a bullish trend. Conversely, a downwardly sloping average line indicates that as time passes, the average return decreases, and is thus indicative of a bullish trend.

Although presentation of the measure of central tendency (e.g. average) of the return rates can be useful to a trader making buying or selling decisions, it still might be difficult to discern for the average line 340 only if the risk entailed justifies the potential payout. Towards this end, the hi-low bands above 344 and below 342 showing the variability of the returns—one standard deviation above and below the average—are provided to aid in the trader in the process of visually detecting the variance among return as a function of time. Thus, it is noted that the tighter the band, the less dispersion among the return results, and the more reliable and more tradable the trend illustrated by the average line 340 is.

The measure of central tendency or average may be any appropriate measure known in the art, including but not limited to a median, a mean, a mode and the like.

As shown in FIG. 4, a measure of a relationship between the average return and the variance of the returns as a function of time (e.g. trading day) is provided 332 by the stacked triangles at the bottom of the graph 320. For the particular example of FIG. 4, upward facing triangles include a bullish tendency or “edge,” while downward facing triangles include a bearish tendency or “edge” as illustrated in the edge legend 354. The strength of the edge is expressed by the number of stacked triangles. Furthermore, it is noted that the although not visible in FIG. 4, some embodiments of the present invention provide color coded symbols, where the color is indicative of a bullish or bearish trends. In some embodiments, the standardized green indicates bullishness and indicates bearishness.

The particular signal to noise relationship illustrated in the Edge Indicator symbols 332 for indicating bullishness or bearishness for the example of FIG. 4 is the Sharpe ratio (without the risk-free return variable) or the “z-statistic.” It is the average of all the returns for each date divided by the standard deviation of those returns (represented by the width of the Hi-Lo bands). This ratio represents the ratio between expected payout and expected risk level assumed by buying or selling the financial instrument.

For the particular example of FIG. 4, the actual z-statistic or Sharpe ratio function is not shown displayed but rather a discrete function derived from the z-statistic function. When the ratio is between −0.5 and 0.5, this indicates that absence of a trading edge between the particular trading day and the trading day of the occurrence of the recurring historical event. When the absolute value of the ratio exceeds the threshold value 0.5, that date is awarded a triangle, with additional triangles for each 0.25 increment above 0.5 or below −0.5. Thus, three triangles represent an absolute value of a Sharpe ratio between 0.75 and 1.25.

It will be appreciated that the aforementioned threshold values for representing the discrete function are merely provided as examples, and any appropriate threshold values are within the scope of the present invention. Furthermore, it is noted that the graphical representation of the relationship between the measure of central tendency (e.g. average) and the measure of variance as a discrete function (e.g. a discrete number of symbols) is also only on exemplary representation of this relationship, and is not a limitation of the present invention.

Thus providing these symbols 332 to express a signal to noise ratio saves the trader the hassle and uncertainty of trying to estimate this relationship. Furthermore, a trader deciding exactly when to purchase or sell the commodity simply locates the trading day having the greatest number of bullish or bearish indicator symbols and buys or sells the financial instrument on that day.

Furthermore, it is recognized that edge indicators derived from a greater number of prior occurrences of the historical event tend to be more reliable than comparable edge indicators derived from a smaller number of prior occurrences of the historical event. Towards this end, it is noted that FIG. 4 displays to the user the number 348 of previous occurrences of the event.

Although FIG. 4 paints an optimistic picture of the process of locating tradable edges, it is noted that for a great number of cases, the behavior is random and no edge indicator or no reliable edge indicator is obtained during the proximate time period for a particular financial instrument and a particular recurring event. Thus, it is noted that there is an ongoing need for tools and techniques allowing a trader to judiciously choose an appropriate financial instruments to trade in conjunction with a selected historical event.

The techniques described in FIGS. 5-9 are thus useful in aiding the trader or other market player in answering the fundamental questions: “What instrument to trade?” “Relative to which event should the instrument be traded?” Thus, while the output of FIG. 4 is useful for detecting whether or not a particular defined historical event generates a tradable temporal price movement pattern for a particular selected financial instruments, the interface of FIG. 5-9 are useful in aiding a trader in the processes of observing the current marketplace and selecting appropriate financial instruments and/or recurring historical events in accordance with the observed current marketplace. The user may thus be presented with a matrix of events that have recently occurred allowing for the selection of particular historical events or combination of events of interest which purportedly can influence price movements of the financial instrument for detecting whether or not the historical events generate a repeating pattern of temporal price movement pattern that may represent a trading opportunity.

FIG. 5 provides an image of an exemplary “scan page” interface for presenting a current situation of a financial instrument and/or current market conditions 128 for the date Feb. 24, 2005. According to FIG. 5, a single table summarizing various relevant events triggered by different financial instruments on or before a specific selected trading date 264 is presented. Thus, in one example, a stock trader who is interested in seeking out appropriate financial instruments to trade based upon past pricing history will select the current trading day as the selected trading day 264, and will be presented time relevant data from that particular trading day.

Thus, as illustrated in FIG. 5, the rows of the table are defined as different events definitions 262 while the columns of the table are different categories of financial instruments 266. For each category, and for each event definition, the number of financial instruments that triggered the respective event is displayed.

For the particular example of FIG. 4, standardized categories of stocks are displayed (e.g. Dow 30, S&P 500, NASDAQ 100, etc.) though it is appreciated that a user may define customized financial instrument categories. For the particular example of FIG. 5, the first four event definitions are “up extra big”, “up very big”, “up big,” and “up” defined in Appendix A.

Thus, as illustrated in FIG. 5, it is evident that on the day before Thursday Feb. 24, 2005 (e.g. Wednesday, Feb. 23, 2005) 13 stocks from the NYSE were up extra big, 76 stocks from the NYSE were up only very big, 518 stocks of the NYSE were up only big, and 1887 stocks of the NYSE were only up.

There is no limitation on the specific types of events or event definitions off the present invention. Appropriate types of events include but are not limited to almanac events, events relate to specific companies, and events related to performance of a financial instrument. Furthermore, it is not that events are either pre-schedule events (e.g. release of a monthly CPI) or spontaneous events (e.g. the Fed raises the discount rate at a time in between scheduled meetings). An example of a spontaneous event is a death of an important person (president, CEO of a company, etc).

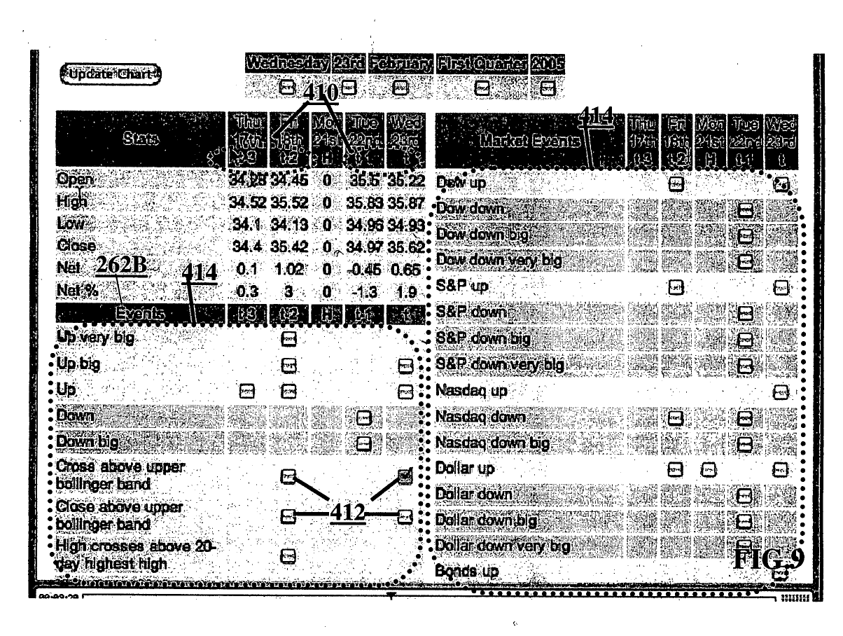

Examples of almanac events include but are not limited to “pure” almanac events and hybrid almanac events describing a non-predetermined outcome that occurred on a pre-determined date. Examples of pure almanac events include but are not limited to quarterly status events (e.g. first quarter, second quarter, third quarter, fourth quarter, an “event” which would be appropriately true or false for every consecutive day of the quarter), market holidays, offsets from market holidays, NAPM report days, and the like. Examples of “hybrid” almanac days include but are not limited to “NAPM lower than expected,” “Confidence higher than expected,” and “Released unemployment rate above 5.3%. Examples of technical events include but are not limited to a financial instrument or financial instrument being up or down a certain level, a crossing or closing above an upper Bollinger band, a crossing above or closing above an all-time high, and the technical events described in FIG. 9. Examples of technical events are also provided in Appendix A.

Sometimes, the historical event may be defined in terms of a time offset from another historical event. Thus, one relevant examples include “three trading days after a trading day where there is a closing above an upper Bollinger band,” and “a trading day where a stock is up extra big, and one trading day after a stock is down extra big” where the latter example could indicate volatility. The former example is an example of a historical event where an “input event” (e.g. closing above an upper Bollinger band) transpired at a time offset from the time of the “historical” event, and the definition includes no input event occurring at the time of the historical event.

Thus, it is noted that no actual event needs occur at the time of the “historical event,” and an “historical event” with given time offset from an actually occurring historical event is also within the scope of the present invention.

It is noted that an example of an event indicating a persistent trend is “a trading day where a stock is up big, one trading day after a stock is up big, and one trading day before a stock is up big.”

Returning to FIG. 5 it is noted that according to the example presented in FIG. 5 the user elects 370A to view a list of the 7 stocks from the S & P 500 that crossed above the upper Bollinger band on Wednesday, Feb. 23, 2005. In one example, the user believes that stocks that exhibited this technical behavior could possibly exhibit a tradable pattern, and according to this example, the interfaces of FIGS. 4, 5 and 7 are operative to assist the trader in defining a tradable combination of a defined event and a selected financial instrument.

This, it is noted that according to some embodiments for each financial instrument category 266 and for each event definition 262, an indication 370 is presented of how many candidate financial instruments in respective financial category satisfy criteria of respective event definition.

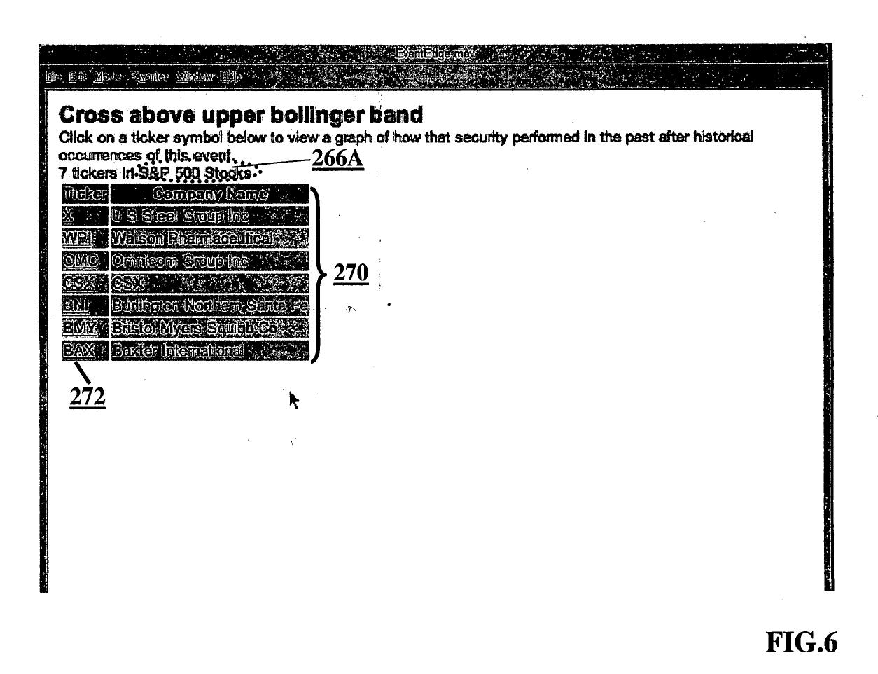

FIG. 6 presents the list of identifiers 270 of individual candidate financial instruments (e.g. stocks)in the selected category of financial instruments (e.g. S&P 500 stocks) that exhibit the behavior defined in the selected event (cross above upper Bollinger band) on the day before the target date (Feb. 24, 2005). The selected event is defined in terms of at least one previously displayed event definition 262. In the example of FIG. 6, the user elects to the specify Baxter International (BAX) 272.

Thus, according to examples of FIGS. 5-6, the user has specified the financial instrument “BAX stock” and the historical event is a time that the “BAX stock” crosses above an upper Bollinger band.

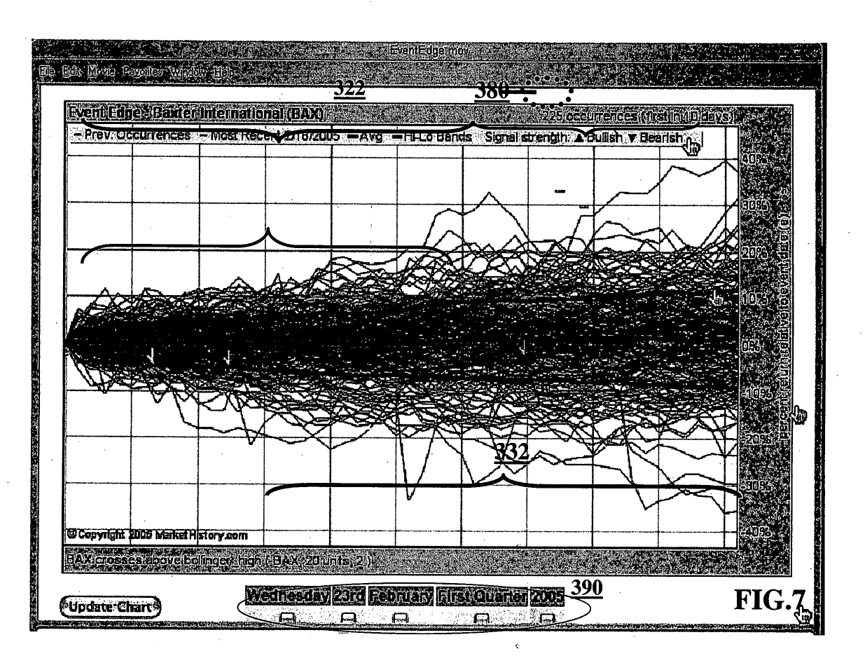

The result of this query is shown in FIG. 7, where it is shown from area 380 at there were 225 occurrences of this event. Unfortunately, the absence of stacked triangle in area 332 indicates that there is no period in the respective proximate time period with a tradable “edge.”

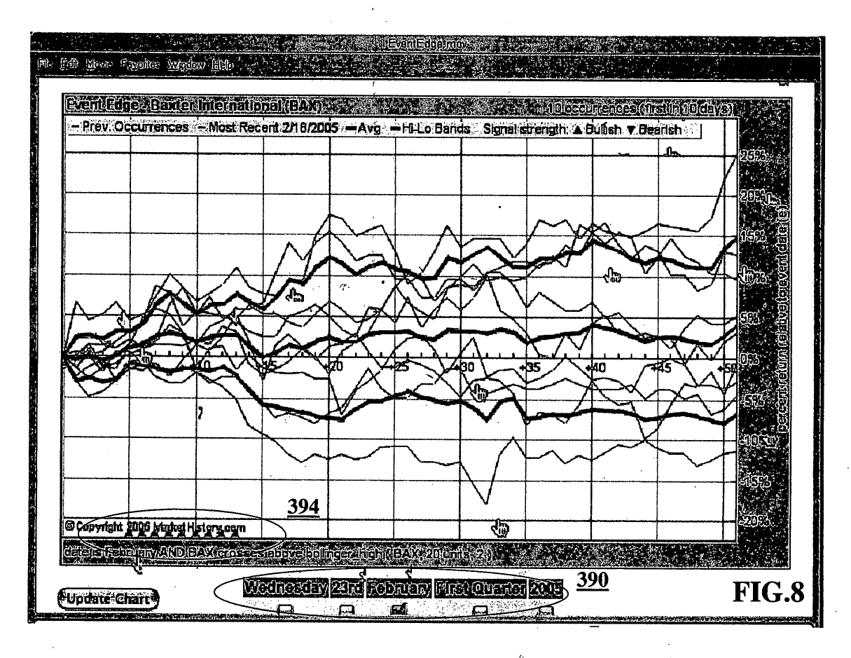

It is noted that FIG. 7 provides a “date characteristics filter” 390 for filtering the historical events. Thus, according to the “data characteristics filter” 390, the historical events can be limited to only historical events that occurred on Wednesday, only historical events that occurred on the 23^{rd} of the month, only historical events that occurred during the first quarter, and only historical events that occurred in 2005. Thus, the “date characteristics filter” 390 of FIGS. 7-8 present date characteristics associated with the reference trading date Wednesday, Feb. 23, 2005.

FIG. 8 shows how judicious selection of event “filtering characteristics” (e.g. features that the historical event must have), which concomitantly reduces the number of prior occurrences of the historical event, can also yield a chart with a tradable edge. Thus, in some embodiments, the process of specifying the historical event and/or financial instrument and generating transformed data is an iterative process, which is repeated until the trader feels that his research of past price data has yielded an appropriate financial instrument and historical event to trade.

Thus, as shown in FIG. 8, the historical event is limited to only cases in February, and thus the 225 occurrences gets reduced to 10 occurrences. Nevertheless, it is noted that further specifying characteristics of the historical event (e.g. it must occur in February) has yielded a bullish tendency from 5 to 13 trading days after the event (see 394).

According to some embodiments, the specifying of the financial instrument 208 includes the steps: for a given trading day (for example, as shown in 264), specifying a plurality of candidate financial instruments (for example, by specifying a stock index 266) and at least one event definition (for example, 262), presenting identifiers for at least a sub-plurality (for example, 270) of candidate financial instruments selected from the plurality of financial instruments (for example all stocks in the stock index 266) that each satisfy criteria of one event definition on the given trading day, selecting a candidate financial instrument (for example, by selecting 272 from 270 in FIG. 6) from the sub-plurality, to specify the financial instrument.

According to some embodiments, each candidate financial instrument (for example 270) is associated with at least one financial instrument category (for example 266A), the specifying of the financial instrument further includes specifying the financial instrument category (for example, choosing among the categories 266) and the presenting of the identifiers includes presenting only identifiers (for example, 270) of financial instruments associated with the specified financial instrument category.

According to some embodiments for each financial instrument category (for example, 266) and for each event definition (for example, 262) , an indication (for example 270) of how many candidate financial instruments in respective financial category satisfied criteria of respective event definition is presented.

It is noted that the “date characteristic filter” of 390 is only one exemplary interface for further “refining the financial instrument/historical event query” by further defining historical events, and another exemplary interface is described in FIG. 9.

It is noted that the “date characteristic filter” of 390 is only one exemplary interface for further “refining the financial instrument/historical event query” by further defining historical events, and another exemplary interface is described in FIG. 9.

According to some embodiments, the defining of the historical event includes the steps of specifying a reference financial instrument (for example, specifying 272 BAX in FIG. 6), specifying a reference trading date (for example, specifying 264 the day before Feb. 24, 2005 in FIG. 5), for at least one trading day (for example, 410 in FIG. 9, or February 17, February 18, February 22, and February 23) associated with the reference trading day (e.g. Feb. 23, 2005 in FIG. 9), for a plurality of trading day characteristics, displaying an indication (for example, 412 in FIG. 9) of whether or not on the associated trading day the reference financial instrument exhibited a trading day characteristic, presenting an input user (for example, 412) interface for defining characteristics of a trading day associated with the historical event, where user interface includes the displayed indications, and receiving directives to define the historical event through the input user interface.

According to some embodiments, the defining of the historical event includes the steps of presenting a plurality of identifiers of input events (for example, 262B), each input event associated with a given trading day, selecting at least a sub-plurality of the plurality of input events (for example, checking boxes 412), and defining the historical event to be an event that occurs when the inputs events of the selected sub-plurality occur.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

### Appendix A

Appendix A presents a list of technical events that capture everyday and extreme movements of stocks very well. Here are some brief descriptions of how they work.

Up/Down

The first set of events covers the Up/Down pattern of movements of the closing price over the last five trading days. The most basic event pair, Up/Down, indicates whether the price of the instrument gained or lost on the previous day. This set of events also indicates more extreme moves: Up/Down ‘Big’, ‘Very Big’, or ‘Extra Big’. These events show one-day percentage change moves that are one, two, or three standard deviations, respectively, larger than the average one-day percentage change over the last 30 trading days. Some people refer to these as ‘sigma’ moves because the Greek letter sigma is often used to denote the standard deviation in mathematical notation.

Bollinger Bands

The Bollinger Bands are a widely followed indicator which shows a statistical estimation of the volatility of an instrument based on the standard deviation of the last 20 trading days worth of daily price changes. The bands are plotted two standard deviations above and below the 20-day average price. This event is triggered when the close crosses above the upper and below the lower bands. There is a second event defined that is true when the close is above or below the bands without regard to whether it was above or below the band on the previous day.

New Highs/New Lows

These events are triggered when the intra-day highs and lows indicate that during the trading day the instrument has traded at a price that the instrument has not traded at in more than some number of days. We look at 20 day, 50 day, 13-week (65 days), 52-week (one year) and all-time highs and lows. The 20 and 50 day highs and lows are used in the famous “Turtle” trading system.

MACD Crossovers

This event shows when the standard Moving Average Convergence/Divergence (MACD) triggers a signal, where by the faster “Signal” line crosses above or below the slower MACD line.

Unusual Volume

This event is triggered when the instrument's volume exceeds four times the average volume over the last 20 trading days.

Five-Day Gains/Losses

These are similar to the Up/Down events discussed above, but they look at the five-day percentage change in price. Same gradations apply—Big, Very Big, Extra Big referring to one, two and three-standard deviation five-day moves.

Moving Average Crossovers

These events show when the price of the instrument crosses above of below the 50, 100, or 200-day average price, signaling a change in trend.

50-Day MA Cross Above/Below 200-Day MA

This event is a long-term trend indicator—it occurs when the 50-day average crosses above or below the 200-day average price.

Bullish/Bearish MACD Crossover

This event occurs when the MACD line crosses above or below the Signal line of this widely followed indicator.

Extremely Large Range

A daily range that is more than three standard deviations stronger than the average daily range over the last 30 trading days.

Very Large Range

A daily range that is more than two standard deviations stronger than the average daily range over the last 30 trading days.

Small Range

A daily range that is more than one standard deviations smaller than the average daily range over the last 30 trading days.

Very Small Range

A daily range that is more than two standard deviations smaller than the average daily range over the last 30 trading days.

Inside Day

The high-low range of the day is contained within the range of the previous trading day, that is, the high is lower than the previous day's high and the low is higher than the previous day's low.

Outside Day

The high-low range of the day is outside the range of the previous trading day, that is, the high is higher than the previous day's high and the low is lower than the previous day's low.

Gap Up

The daily low is higher than the previous day's high price.

Gap Down

The daily high is lower than the previous day's low price.

Bullish Reversal

The daily low is lower than the previous day's low, but the close is higher than the previous day's close.

Bearish Reversal

The daily high is higher than the previous day's high, but the close is lower than the previous day's close.

What is claimed is:

1. A method of providing information about price movements before or following a recurring historical event, the method comprising:
a) specifying the target financial instrument;
b) defining the recurring historical event;
c) for each of a plurality of respective prior occurrences of said historical event, for a plurality of distinct times during a respective time period in proximity to a time of said respective prior occurrence, computing a return of said financial instrument relative to a substantially single respective reference time; and
d) presenting at least one function of said computed returns.

2. The method of claim 1 wherein each said respective reference time has substantially the same relation to said respective time of said respective prior occurrence.

3. The method of claim 1 wherein each said respective reference time occurs within one trading day of said respective time of said respective prior occurrence.

4. The method of claim 3 wherein each said respective reference time is a substantially fixed time of a trading date selected from the group consisting of a trading date during which said respective historical event occurs, and a first trading date after said respective occurrence of said historical event.

5. The method of claim 4 wherein said substantially fixed time within a trading date is a substantially a close of trading.

6. The method of claim 1 wherein each said respective reference time has a substantially equal time offset from said respective time of occurrence of said historical event.

7. The method of claim 1 wherein for each said respective reference time, a time difference between said respective reference time and said respective time of occurrence is at most a predetermined value.

8. The method of claim 1 wherein each said respective reference time is said respective time of occurrence of said historical event.

9. The method of claim 1 wherein for a given said distinct time, said computing of said return includes computing a difference between a price of said financial instrument at said given distinct time and a price of said financial instrument at said respective reference time.

10. The method of claim 9 wherein for said given distinct time, said computing of said return includes dividing said difference by a price of said financial instrument at said respective reference time.

11. The method of claim 1 wherein said return of said financial instrument is a function of a relative percentage change of a price of said financial instrument between said reference time and a said distinct time.

12. The method of claim 1 wherein a difference between each said distinct time during said proximate time period and a time of said respective occurrence is at most 50 trading days.

13. The method of claim 1 wherein each said respective proximate time period is a multi-trading day time period, and for each said respective proximate time period, said return is computed for times on different trading days.

14. The method of claim 1 wherein one said presented function is an identity function, and said presenting includes presenting said respective individual computed returns for each of said plurality of prior occurrences.

15. The method of claim 1 wherein a plurality of functions are presented, each respective function of said plurality is associated with a respective prior occurrence, and said plurality of functions is presented using a substantially common time scale relative to said respective historical events.

16. The method of claim 1 wherein one said presented function is a function of a plurality of individual said computed returns.

17. A computer readable storage medium having computer readable code embodied on said computer readable storage medium, said computer readable code for providing information about price movements before or following a recurring historical event, said computer readable code including instructions for:
a) specifying the target financial instrument;
b) defining the recurring historical event;
c) for each of a plurality of respective prior occurrences of said historical event, for a plurality of distinct times during a respective time period in proximity to a time of said respective prior occurrence, computing a return of said financial instrument relative to a substantially single respective reference time; and
d) presenting at least one function of said computed returns.

18. The computer readable storage medium of claim 17, wherein for each of the plurality of respective prior occurrences of said historical event, accessing a set of price data of the financial instrument during a respective time period in proximity to a time of said respective prior occurrence, and wherein:
a) for each respective said proximate time period, determining the respective substantially single reference time; and
b) re-scaling each respective said accessed set of price data to a substantially common price or performance scale by computing, for a respective plurality of distinct times during each said respective proximate time period, a function of a price of the financial instrument at said distinct time and the price of the financial instrument at said respective reference time.

19. A system for providing information about price movements before or following a recurring historical event, the system comprising:
a) an input interface for specifying the target financial instrument and the recurring historical event;
b) a data retrieval engine for accessing price data of said target financial instrument during respective time periods in proximity of a plurality of respective occurrences of said recurring historical event;
c) a data transformation engine for computing, for each of a plurality of respective prior occurrences of said historical event, for a plurality of distinct times during a respective time period in proximity to a time of said respective prior occurrence, a return of said financial instrument relative to a substantially single respective reference time; and
d) a presentation interface for presenting at least one function of said computed returns.

20. The system of claim 19 wherein the data retrieval engine accesses for each of the plurality of respective prior occurrences of said historical event, a set of price data of the financial instrument during a respective time period in proximity to a time of said respective prior occurrence, and wherein the data transformation engine re-scales each respective said accessed set of price data to a substantially common price or performance scale by computing, for a respective plurality of distinct times during each said respective proximate time period, a function of a price of the financial instrument at said distinct time and a price of the financial instrument at a respective substantially single reference time associated with said respective occurrence.
